(19) United States
(12) Patent Application Publication
(10) Pub. No.: US 2014/0273807 A1
(43) Pub. Date: Sep. 18, 2014

(54) Grille Shutter Assembly

(71) Applicant: SRG GLOBAL , INC., Warren, MI (US)

(72) Inventor: Robert W. FRAYER, III, Ferndale, MI (US)

(73) Assignee: SRG GLOBAL , INC., Warren, MI (US)

(21) Appl. No.: 13/834,908

(22) Filed: Mar. 15, 2013

(51) Int. Cl. B60K 11/08

(52) U.S. Cl. CPC B60K 11/085
USPC 454/335

(57) ABSTRACT

A grille assembly for a vehicle may include a grille frame and a plurality of louvers. The grille frame may include an opening. The plurality of louvers may be mounted directly to the grille frame and may extend across at least a portion of the opening. The louvers may be movable relative to the grille frame between an open position in which air is allowed to flow through the opening and a closed position in which airflow through the opening is restricted.

### FIELD

The present disclosure relates to a shutter assembly, and more particularly, to a grille shutter assembly for a vehicle.

### BACKGROUND

This section provides background information related to the present disclosure and is not necessarily prior art.

Many automotive vehicles include a grille mounted to a front end of the vehicle. Grilles are often an important component of the vehicle's aesthetic appeal and may serve to identify a brand of the vehicle. A grille may allow airflow into an engine or motor compartment of the vehicle to cool various vehicle components such as a radiator, an engine and/or an electric motor, for example, and/or various vehicle fluids such as coolant, lubricants and/or refrigerant, for example. While this airflow into the engine compartment may be desirable under certain operating conditions, it may also increase aerodynamic drag on the vehicle, which can reduce fuel efficiency. A grille shutter assembly may be provided to selectively block airflow into the engine compartment under predetermined operating conditions to reduce aerodynamic drag on the vehicle and increase fuel efficiency.

### SUMMARY

This section provides a general summary of the disclosure, and is not a comprehensive disclosure of its full scope or all of its features.

In one form, the present disclosure provides a grille assembly for a vehicle that may include a grille frame and a plurality of louvers. The grille frame may include an opening. The plurality of louvers may be mounted directly to the grille frame and may extend across at least a portion of the opening. The louvers may be movable relative to the grille frame between an open position in which air is allowed to flow through the opening and a closed position in which airflow through the opening is restricted.

In some embodiments, the plurality of louvers may extend vertically across the opening.

In some embodiments, the grille assembly may include another plurality of louvers extending across at least a portion of another opening defined by the grille frame.

In some embodiments, the grille frame may be free from structure traversing the opening that obstructs visibility of the plurality of louvers when viewed from a front end of the vehicle when the louvers are in the open position and when the louvers are in the closed position.

In some embodiments, the louvers may include a V-shaped cross section.

In some embodiments, the grille assembly may include a gear driven by a drive motor and meshingly engaging a geared surface formed on one of the plurality of louvers. In some embodiments, the one of the plurality of louvers may be coupled with others of the plurality of louvers by first and second links rotatably coupled to each other.

In some embodiments, a gear driving another plurality of louvers extending across at least a portion of another opening defined by the grille frame.

In another form, the present disclosure provides a grille assembly for a vehicle that may include a grille frame and a plurality of louvers. The grille frame may include an opening. The plurality of louvers may extend across at least a portion of the opening and may be movable relative to the grille frame between an open position in which air is allowed to flow through the opening and a closed position in which airflow through the opening is restricted. The grille frame may be free from structure traversing the opening that obstructs visibility of the plurality of louvers when viewed from a front end of the vehicle when the louvers are in the open position and when the louvers are in the closed position.

In some embodiments, the plurality of louvers may extend vertically across the opening.

In some embodiments, the grille assembly may include another plurality of louvers extending across at least a portion of another opening defined by the grille frame.

In some embodiments, the louvers may include a V-shaped cross section.

In some embodiments, the grille assembly may include a gear driven by a drive motor and meshingly engaging a geared surface formed on one of the plurality of louvers. In some embodiments, the one of the plurality of louvers may be coupled with others of the plurality of louvers by first and second links rotatably coupled to each other. In some embodiments, the grille assembly may include another gear driving another plurality of louvers extending across at least a portion of another opening defined by the grille frame.

In another form, the present disclosure provides a grille assembly for a vehicle that may include a grille frame, a plurality of first louvers, and a plurality of second louvers. The grille frame may include a first opening and a second opening spaced horizontally apart from the first opening. The plurality of first louvers may be mounted directly to the grille frame and may extend across at least a portion of the first opening. The first louvers may be movable relative to the grille frame between an open position in which air is allowed to flow through the opening and a closed position in which airflow through the opening is restricted. The plurality of second louvers may be mounted directly to the grille frame and may extend across at least a portion of the second opening. The second louvers may be movable relative to the grille frame between an open position in which air is allowed to flow through the opening and a closed position in which airflow through the opening is restricted. The grille frame may be free from structure traversing the first opening and free from structure traversing the second opening that obstructs visibility of the first and second louvers when viewed from a front end of the vehicle when the first and second louvers are in the open position and when the first and second louvers are in the closed position.

In some embodiments, the grille assembly may also include first and second gears and first and second linkages. The first gear may be driven by a drive motor and may meshingly engage a first geared surface formed on one of the plurality of first louvers. The second gear may be meshingly engaged with the first gear and a second geared surface formed on one of the plurality of second louvers. The first linkage may connect the one of the plurality of first louvers with others of the plurality of first louvers. The second linkage may connect the one of the plurality of second louvers with others of the plurality of second louvers.

In some embodiments, the first louvers may be arranged in a generally horizontally extending first line, and the second louvers may be arranged in a generally horizontally extending second line that is angled relative to the first line.

In some embodiments, the first and second louvers may extend vertically across the first and second openings, respectively.

In some embodiments, the first and second louvers may include V-shaped cross sections.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of a grille assembly having a plurality of movable louvers according to the principles of the present disclosure;

FIG. 2 is partially exploded perspective view of the grille assembly of FIG. 1;

FIG. 3 is a top view of the grille assembly of FIG. 1 with the louvers in an open position;

FIG. 4 is a top view of the grille assembly of FIG. 1 with the louvers in a closed position;

FIG. 5 is a cross-sectional view of the louvers and a grille frame of the grille assembly;

FIG. 6 is a partial perspective view of a drive mechanism of the grill assembly; and

FIG. 7 is another partial perspective view of the drive mechanism.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With reference to FIGS. 1-7, a grille assembly 10 is provided that may include a grille frame 12 and a grille shutter assembly 14. The grille assembly 10 may be attached to a front end of a vehicle. The grille shutter assembly 14 may selectively allow and restrict airflow through the grille frame 12 based on one or more operating conditions, such as vehicle speed, throttle position, engine speed, engine load, engine temperature, electric-motor-temperature (e.g., for an electric or hybrid-electric vehicle), coolant temperature or pressure, lubricant temperature or pressure, and/or refrigerant temperature or pressure, for example, and/or other vehicle operating conditions.

The grille frame 12 may include a frame body 16 having a generally horizontally extending upper portion 18 and a generally horizontally extending lower portion 20. The upper and lower portions 18, 20 may define first and second openings 22, 24 extending through the frame body 16. The upper portion 18 may include a plurality of integrally formed tabs 26 (FIG. 2) disposed adjacent the first and second openings 22, 24 and extending rearward from a rearward facing side 28 of the frame body 16. Each of the tabs 26 may include an aperture or slot 30 formed therein. The lower portion 20 may include a plurality of slots or apertures 31 (FIG. 2).

The grille shutter assembly 14 may be attached to the grille frame 12 and may include a plurality of first louvers 32, a plurality of second louvers 34, a drive motor 36, a first drive linkage 38, and a second drive linkage 40. The louvers 32, 34 may be rotatable relative to the grille frame 12 between an open position (FIGS. 1 and 3) in which air is allowed to flow through the openings 22, 24 and a closed position (FIG. 4) in which air is restricted or prevented from flowing through the openings 22, 24.

Each of the louvers 32, 34 may include a generally V-shaped cross section (FIG. 5). As shown in FIGS. 1 and 2, the first and second louvers 32, 34 may extend vertically between the upper and lower portions 18, 20 of the grille frame 12 such that the first louvers 32 traverse the first opening 22 and the second louvers 34 traverse the second opening 24. Each of the first and second louvers 32, 34 may include a first axle peg 42 and a second axle peg 44. The first axle pegs 42 of the louvers 32, 34 may extend through the slots 30 and are rotatable therein relative to the grille frame 12. The second axle pegs 44 of the louvers 32, 34 may extend through the apertures 31 and are rotatable therein relative to the grille frame 12. The slots 30 and apertures 31 may define bearing surfaces rotatably supporting the axle pegs 42, 44. In some embodiments, bearing inserts may be received in the slots 30 and/or apertures 31 to rotatably support the axle pegs 42, 44. In some embodiments, bearing caps may be attached to the grille frame 12 and may cover the slots 30 and first axle pegs 42 to retain the first axle pegs 42 in the slots 30.

In some embodiments, some or all of the first axle pegs 42 of the first louvers 32 may be arranged into a linear configuration such that a first line can be drawn through some or all of the first axle pegs 42. Similarly, some or all of the first axle pegs 42 of the second louvers 34 may be arranged into a linear configuration such that a second line can be drawn through some or all of the first axle pegs 42. In some embodiments, the first and second lines may be angled relative to each other. In some embodiments, the first and second lines may be curved lines. Such configurations may allow the louvers 32, 34 to be positioned closer to the openings 22, 24 or in the openings 22, 24. In some embodiments, the arrangement of the first axle pegs 42 relative to each other and the grille frame 12 may be selected to provide a desired aesthetic appeal.

In some prior-art grille assemblies, the grille frame includes ribs and/or bars traversing (or partially traversing) the openings of the grille frame to achieve a desired aesthetic look. In such prior-art grille assemblies, louvers of grille shutter systems are positioned such that the louvers are partially or entirely hidden from view (when looking at the front end of the vehicle) when the louvers are in an open position. In the exemplary embodiment shown in the figures of the present disclosure, the grille frame 12 of the present disclosure may be free from such ribs and/or bars traversing (or partially traversing) the openings 22, 24, and therefore, the louvers 32, 34 are not partially or entirely hidden from view by structure traversing the openings 22, 24 when the louvers 32, 34 are in the open position or in the closed position. Rather, the louvers 32, 34 may be formed so that when the louvers 32, 34 are in the open position, the louvers 32, 34 resemble the bars or ribs of a particular automobile manufacturer's prior-art grille assembly (when viewed from the frame of reference of a person standing in front of the vehicle and looking at the front end of the vehicle). Accordingly, in some embodiments, tips 50 and/or outer faces 52 of the louvers 32, 34 may include a chrome, black and/or any other decorative coating, plating or finish, for example, and/or other decorative features. In some embodiments, the louvers 32, 34 may be the only structures extending across or partially across the openings 22, 24. It will be appreciated, however, that the principles of the present disclosure are also applicable to grille frames 12 having one or more bars, ribs, wire mesh structures and/or other structures traversing or partially traversing the openings 22, 24 in addition to the louvers 32, 34.

The drive motor 36 may be disposed within a housing 54 (FIGS. 1-3) that may be integrally formed with or attached to the grille frame 12. The drive motor 36 can be any suitable type of motor and may be controlled by an electronic control module, for example. As described above, the control module may operate the drive motor 36 based on one or more vehicle operating conditions. The drive motor 36 may be drivingly connected to the first and second drive linkages 38, 40 and may cause rotation of the louvers 32, 34 between the open and closed positions. As described above, in the open position, air may flow through the openings 22, 24 of the grille frame 12 and into a compartment of the vehicle to cool various vehicle components (e.g., an engine, radiator, motor, etc.). In the closed position, air may be restricted or prevented from flowing through the openings 22, 24, and instead, is directed around the exterior of the front end of the vehicle, thereby reducing aerodynamic drag on the vehicle. It will be appreciated that the louvers 32, 34 may be moved to any of a plurality of positions between the fully open and fully closed positions.

As shown in FIGS. 3, 4 and 7, first and second gears 56, 58 may be coupled to the drive motor 36. The drive motor 36 may drive one of the first and second gears 56, 58, which in turn, may drive the other of the first and second gears 56, 58 in an opposite direction. The first gear 56 may meshingly engage a first geared surface 60 of a first flange 62 (FIG. 7) integrally formed with and extending from an innermost one of the first louvers 32. Similarly, the second gear 58 may meshingly engage a second geared surface 64 of a second flange 66 (FIG. 7) integrally formed with and extending from an innermost one of the second louvers 34. The first and second geared surfaces 60, 64 can be molded into the first and second innermost louvers 32, 34, respectively, or machined therein. In some embodiments, the first and second geared surfaces 60, 64 could be molded onto the first and second louvers 32, 34 with a different material than the material forming the rest of the first and second louvers 32, 34. In some embodiments, the flanges 62, 66 and geared surfaces 60, 64 may be separate components from the innermost louvers 32, 34 that can be fastened thereto.

Rotation of an output shaft of the drive motor 36 in a first direction may cause rotation of the innermost first and second louvers 32, 34 toward the open position, and rotation of the output shaft of the drive motor 36 in a second direction may cause rotation of the innermost first and second louvers 32, 34 toward the closed position. The first drive linkage 38 may interconnect the innermost first louver 32 with the rest of the first louvers 32 so that rotation of the innermost first louver 32 between the open and closed positions causes corresponding rotation of the rest of the first louvers 32 between the open and closed positions. Similarly, the second drive linkage 40 may interconnect the innermost second louver 34 with the rest of the second louvers 34 so that rotation of the innermost second louver 34 between the open and closed positions causes corresponding rotation of the rest of the second louvers 34 between the open and closed positions.

As shown in FIG. 4, each of the first and second drive linkages 38, 40 may include a first link 70 and a second link 72. The innermost first and second louvers 32, 34 may include a first peg 74, and the rest of the first and second louvers 32, 34 may include a second peg 76 extending from arms 78 integrally formed with the rest of the louvers 32, 34. The first link 70 of the first drive linkage 38 may be rotatably coupled to the first peg 74 of the innermost first louver 32 and rotatably coupled to the second peg 76 of the first louver 32 directly adjacent the innermost first louver 32. The second link 72 may include a plurality of apertures 80 (FIG. 2) that rotatably engage the second pegs 76 of the first louvers 32. Similarly, the first link 70 of the second drive linkage 40 may be rotatably coupled to the first peg 74 of the innermost second louver 34 and rotatably coupled to the second peg 76 of the second louver 34 directly adjacent the innermost second louver 34. The second pegs 76 of the second louvers 34 may rotatably engage the apertures 80 of the second link 72 of the second drive linkage 40.

In some embodiments, the first and second drive linkages 38, 40 may be configured so that an angle between a first line L1 (FIGS. 3 and 4) connecting adjacent second pegs 76 and a second line L2 (FIGS. 3 and 4) connecting one of the second pegs 76 corresponding to a particular louver 32, 34 and the first axle peg 42 of the same particular louver 32, 34 may be between about 70 and 90 degrees (e.g., about 80 degrees) when the louvers 32, 34 are in the closed position, as shown in FIG. 4. When the louvers 32, 34 are in the open position, the angle between the same first and second lines L1, L2 may be greater than 100 degrees (e.g., about 138 degrees), as shown in FIG. 3. Such a configuration allows for greater torque to be exerted on the louvers 32, 34 by the drive linkages 38, 40 when the louvers 32, 34 are at or near the closed position. While the particular embodiment depicted includes about 58 degrees of rotation between the open and closed positions, in some embodiments, the amount of rotational motion between the open and closed positions could be more or less than 58 degrees.

In the particular embodiment depicted in the figures, the first louvers 32 may rotate in a first rotational direction when moving from the closed position to the open position, and the second louvers 34 may rotate in a second rotational direction opposite the first rotational direction when moving from the closed position to the open position.

In the particular embodiment depicted in the figures, the axes about which the louvers 32, 34 rotate may not be parallel to each other. For example, each of the first louvers 32 may rotate about corresponding rotational axes that may not all be parallel to each other. Likewise, each of the second louvers 34 may rotate about corresponding rotational axes that may not all be parallel to each other or parallel to the rotational axes of the first louvers 32. Accordingly, each aperture 80 of the second links 72 may be formed at angles corresponding to the orientation of the rotational axis of the particular louver 32, 34 engaging that aperture 80. That is, the apertures 80 may include longitudinal axes that are angled relative to each other to match the angles of the rotational axes of the louvers 32, 34.

It will be appreciated that any other suitable drive mechanism could be employed to move the louvers 32, 34 between the open and closed positions. In some embodiments, the drive mechanism could be configured to rotate the first and second louvers 32, 34 in the same direction when moving the first and second louvers 32, 34 from the closed position to the open position. Furthermore, while the louvers 32, 34 are shown in the figures extending vertically across the openings 22, 24, in some embodiments, the louvers 32, 34 could be oriented horizontally to extend horizontally across one or more openings of the grille frame 12. It will also be appreciated that the principles of the present disclosure are also applicable to grille frames having more or less than two openings.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A grille assembly for a vehicle comprising:
a grille frame including an opening; and
a plurality of louvers mounted directly to the grille frame and extending across at least a portion of the opening, the louvers being movable relative to the grille frame between an open position in which air is allowed to flow through the opening and a closed position in which airflow through the opening is restricted.

2. The grille assembly of claim 1, wherein the plurality of louvers extend vertically across the opening.

3. The grille assembly of claim 1, further comprising another plurality of louvers extending across at least a portion of another opening defined by the grille frame.

4. The grille assembly of claim 1, wherein the grille frame is free from structure traversing the opening that obstructs visibility of the plurality of louvers when viewed from a front end of the vehicle when the louvers are in the open position and when the louvers are in the closed position.

5. The grille assembly of claim 1, wherein the louvers include a V-shaped cross section.

6. The grille assembly of claim 1, further comprising a gear driven by a drive motor and meshingly engaging a geared surface formed on one of the plurality of louvers.

7. The grille assembly of claim 6, wherein the one of the plurality of louvers is coupled with others of the plurality of louvers by first and second links rotatably coupled to each other.

8. The grille assembly of claim 7, further comprising another gear driving another plurality of louvers extending across at least a portion of another opening defined by the grille frame.

9. A grille assembly for a vehicle comprising:
a grille frame including an opening; and
a plurality of louvers extending across at least a portion of the opening and movable relative to the grille frame between an open position in which air is allowed to flow through the opening and a closed position in which airflow through the opening is restricted,
wherein the grille frame is free from structure traversing the opening that obstructs visibility of the plurality of louvers when viewed from a front end of the vehicle when the louvers are in the open position and when the louvers are in the closed position.

10. The grille assembly of claim 9, wherein the plurality of louvers extend vertically across the opening.

11. The grille assembly of claim 9, further comprising another plurality of louvers extending across at least a portion of another opening defined by the grille frame.

12. The grille assembly of claim 9, wherein the louvers include a V-shaped cross section.

13. The grille assembly of claim 9, further comprising a gear driven by a drive motor and meshingly engaging a geared surface formed on one of the plurality of louvers.

14. The grille assembly of claim 13, wherein the one of the plurality of louvers is coupled with others of the plurality of louvers by first and second links rotatably coupled to each other.

15. The grille assembly of claim 14, further comprising another gear driving another plurality of louvers extending across at least a portion of another opening defined by the grille frame.

16. A grille assembly for a vehicle comprising:
a grille frame including a first opening and a second opening spaced horizontally apart from the first opening;
a plurality of first louvers mounted directly to the grille frame and extending across at least a portion of the first opening, the first louvers being movable relative to the grille frame between an open position in which air is allowed to flow through the opening and a closed position in which airflow through the opening is restricted; and
a plurality of second louvers mounted directly to the grille frame and extending across at least a portion of the second opening, the second louvers being movable relative to the grille frame between an open position in which air is allowed to flow through the opening and a closed position in which airflow through the opening is restricted,
wherein the grille frame is free from structure traversing the first opening and free from structure traversing the second opening that obstructs visibility of the plurality of first and second louvers when viewed from a front end of the vehicle when the first and second louvers are in the open position and when the first and second louvers are in the closed position.

17. The grille assembly of claim 16, further comprising:
a first gear driven by a drive motor and meshingly engaging a first geared surface formed on one of the plurality of first louvers;
a second gear meshingly engaged with the first gear and a second geared surface formed on one of the plurality of second louvers;
a first linkage connecting the one of the plurality of first louvers with others of the plurality of first louvers; and
a second linkage connecting the one of the plurality of second louvers with others of the plurality of second louvers.

18. The grille assembly of claim 16, wherein the first louvers are arranged in a generally horizontally extending first line, and the second louvers are arranged in a generally horizontally extending second line that is angled relative to the first line.

19. The grille assembly of claim 18, wherein the first and second louvers extend vertically across the first and second openings, respectively.

20. The grille assembly of claim 19, wherein the first and second louvers include V-shaped cross sections.
